(19) United States
(12) Patent Application Publication
(10) Pub. No.: US 2009/0095795 A1
(43) Pub. Date: Apr. 16, 2009

(54) TOOL ASSEMBLY USED WITH FRICTION STIR WELDING

(75) Inventors: Frank Hunt, West Bloomfield, MI (US); Harsha Badarinarayan, Novi, MI (US); Kazutaka Okamoto, Novi, MI (US)

Correspondence Address: GIFFORD, KRASS, SPRINKLE,ANDERSON & CITKOWSKI, P.C, PO BOX 7021, TROY, MI, 48007-7021, US

(73) Assignee: Hitachi, Ltd, Tokyo (JP)

(21) Appl. No.: 12/337,062

(22) Filed: Dec. 17, 2008

Related U.S. Application Data
(62) Division of application No. 11/425,798, filed on Jun. 22, 2006.

(51) Int. Cl. B23K 20/12; F16B 35/04

(52) U.S. Cl. 228/112.1; 411/383; 228/2.1

(57) ABSTRACT

A tool assembly which is particularly suitable for friction stir welding applications. The tool assembly includes a holder having an axis and one end adapted to be rotatably driven by a rotary drive mechanism about the holder axis. A tool having an axis is also provided and includes a tool tip at one end. A fastener detachably and coaxially secures the holder and tool together. This fastener includes a first part secured to the second end of the holder and a second part secured to the second end of the tool.

### CROSS-REFERENCE TO RELATED APPLICATIONS

This Application is a Division of application Ser. No. 11/425,798 filed on Jun. 22, 2006.

### FIELD OF THE INVENTION

The present invention relates generally to a tool assembly for manufacturing operations.

### DESCRIPTION OF THE RELATED ART

There are many previously known tool assemblies for selectively coupling different tools to a chuck. Once connected, the chuck is then rotatably driven by a motor to perform the desired machining operation. Such machining operations can include, for example, drilling, deburring, grinding, and the like.

The previously known tool assemblies, however, suffer from a number of disadvantages. One disadvantage is that the tool assembly is not only expensive to manufacture, but is also relatively heavy. Consequently, these previously known tool holders are not well suited for machining operations using robotic arms since such robotic arms of the type used in manufacturing operations have a limited weight capacity.

A still further disadvantage of these previously known tool assemblies is that such tool assemblies are not well suited for friction stir welding operations. In particular, in friction stir welding operations, the weld is oftentimes formed on relatively small components. However, due to the size and bulk of these previously known tool assemblies, it is impractical, and sometimes impossible, to manipulate the friction stir welding tool in order to obtain the desired weld.

For example an exemplary prior art stir welding operation is shown in FIG. 10 in which a stir welding tool 100 is used to join two relatively small plates 102 and 104 together.

### SUMMARY OF THE INVENTION

The present invention provides a tool assembly which overcomes all of the above-mentioned disadvantages of the previously known devices and which is particularly suited for friction stir welding.

In brief, the tool assembly of the present invention comprises a holder having an axis and one end adapted to be attached to and rotatably driven by a rotary drive mechanism. A machining tool also having an axis is provided with a machining bit at one end of the tool.

A fastener then detachably and coaxially secures the other ends of the holder together. In one configuration, the fastener comprises a threaded shank extending axially outwardly from the second end of either the holder or the tool and a complementary threaded bore on the second end of the other of the holder or the tool. Consequently, rotation of the holder in a first direction relative to the tool coaxially attaches the tool and the holder together. Conversely, rotation of the holder relative to the tool in the opposite direction detaches the holder from the tool.

The tool assembly of the present invention is particularly well suited for friction stir welding applications. In friction stir welding applications, it is oftentimes necessary to perform a number of different sequential manufacturing operations on the manufactured component. Such manufacturing operations can include, for example, cutting, grinding, drilling, friction stir welding, deburring and the like. Consequently, in one embodiment of the invention, a plurality of tools each having different manufacturing tips are provided and are selectively attached to the holder as needed for the desired manufacturing operation.

Since both the holder and the tool are relatively compact in size, the tool assembly of the present invention is particularly well suited for robotic operations. In such a robotic operation, the robotic arm selectively attaches the desired machining tool to the holder, performs the manufacturing operation, and then detaches the tool from the holder. Thereafter, the robotic arm under program control may selectively connect the holder to a different tool so that sequential and different machining operations may be easily and more rapidly performed than in prior art devices in which the tool change is relatively slow, particularly where the tool is manually changed.

The present invention also discloses an improved friction stir welding bit which creates a smaller weld bulge than the previously known friction stir welding tools.

### BRIEF DESCRIPTION OF THE DRAWINGS

A better understanding of the present invention will be had upon reference to the following detailed description when read in conjunction with the accompanying drawing, wherein like reference characters refer to like parts throughout the several views, and in which:

FIG. 1 is an exploded side view illustrating a preferred embodiment of the present invention;

FIGS. 2A-2F are side views illustrating alternate embodiments of the tool;

FIG. 3 is a side view similar to FIG. 1, but illustrating the tool holder and tool secured together;

FIG. 4A is a fragmentary longitudinal sectional view illustrating a modification of the present invention;

FIG. 4B is a sectional view taken along line 4B-4B in FIG. 4A;

FIG. 5A is a top plan view of a tool crib and FIG. 5 is a side sectional view thereof;

FIGS. 6A-6F are diagrammatic views illustrating the operation of the present invention;

FIG. 7 is an exemplary motor current chart of a processing cycle of the present invention;

FIG. 8 is an elevational view illustrating a robotic arm application of the present invention;

FIGS. 9A and 9B are side and bottom views, respectively, of a friction stir welding tool;

FIG. 10 is a prior art stir welding operation; and

FIGS. 11A-11C are diagrammatic views illustrating sequential machining operations.

### DETAILED DESCRIPTION OF THE PREFERRED EMBODIMENTS

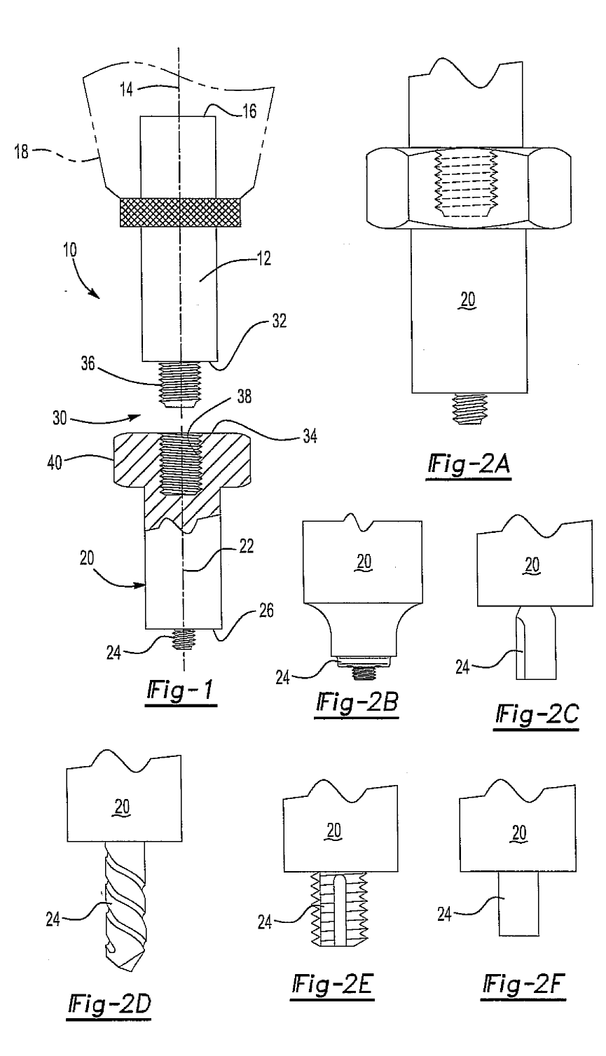

With reference first to FIG. 1, a preferred embodiment of the tool assembly 10 of the present invention is shown and comprises a tool holder 12 having an axis 14. One end 16 of the holder 12 is dimensioned to be attached to a rotary drive mechanism 18. The rotary drive mechanism 18, illustrated only diagrammatically, may be of any conventional configuration and, when activated, rotatably drives the holder 12 about its axis 14.

Still referring to FIG. 1, the tool assembly 10 further includes a tool 20 having an axis 22. A manufacturing tip 24 is provided at a first end 26 of the tool 20. With reference now to FIGS. 2A-2F, the tool tip 24 may take any of a number of different configurations. For example, as shown in FIG. 2A, the tool tip 24 may comprise a friction stir welding tip. In this case, the tool tip 24 comprises an externally threaded shank which is coaxial with the axis 22 of the tool 20. FIG. 2B illustrates a second embodiment of a friction stir welding tip that will be subsequently described in greater detail.

Conversely, the tool tip 24 may comprise a machining tip as shown in FIG. 2C or a drilling tip as shown in FIG. 2D. A tool tip 24 for thread tapping is illustrated in FIG. 2E while a honing or sanding tip is illustrated in FIG. 2F. It will, of course, be understood that other types of tips 24 may be utilized with the tool assembly of the present invention without deviation from either the spirit or scope of the present invention.

Referring again to FIG. 1, a fastener 30 is employed to detachably connect the other ends 32 and 34 coaxially together. The fastener 30, furthermore, includes a first fastener part 36 which is attached to the second end 32 of the holder 12 as well as a second part 38 which is attached to the second end 34 of the tool 20.

The fastener 30 may be of several different forms. For example, in one form the fastener part 36 comprises an externally threaded shank while the second fastener part 38 comprises an internally threaded bore having threads complementary to the threaded shank 36. Both the shank 36 and bore 38 are coaxially aligned with the axes 14 and 22 of the holder 12 and tool 20, respectively. It will be understood, of course, that the threaded shank may alternatively extend outwardly from the tool 20 while the threaded bore may be formed in the holder 12.

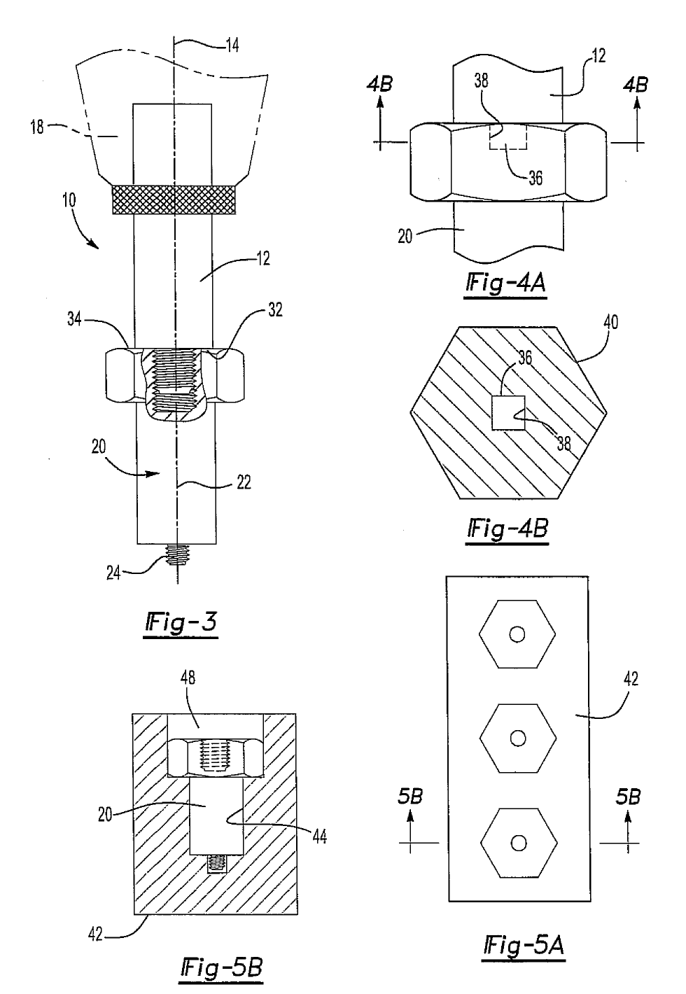

With reference now to FIGS. 1 and 3, in order to attach the holder 12 and tool 20 together, the holder 12 is rotatably driven and axially moved from the position shown in FIG. 1 and to the position shown in FIG. 2 while holding the tool 20 against rotation. In doing so, the threaded shank 36 is positioned within the threaded bore 38 and the second ends 32 and 24 of the holder 12 and tool 20, respectively, flatly abut against each other.

Alternatively, as shown in FIGS. 4A and 4B, the first fastener part 36 may comprise an outwardly protruding shank having a noncircular cross-sectional shape. The second fastener part 38 in this case would comprise a bore having a shape complementary to the first fastener part 36. At least one of the fastener parts 36 or 38, or both, are magnetized.

Consequently, in order to attach the holder 12 and tool 20 together, the holder 12 is moved axially toward the tool 20 and positioned so that the fastener part 36 is aligned with the fastener part 38. Once the fastener part 36 is positioned within the fastener part 38, the holder 12 and tool 20 are held together by magnetism.

With reference now to FIGS. 1, 5A and 5B, the tool 20 includes an enlarged head 40 adjacent its second end 34. Furthermore, this head 40 has a noncircular cross-sectional shape, such as a hexagonal shape as illustrated in the drawing. However, any other noncircular shape may alternatively be used.

Alternatively, the head may be circular in shape but locked against rotation by a pin or other mechanism during attachment and detachment of the tool 20 and holder 12.

In order to hold the tool 20 stationary during the attachment with the holder 12, each tool 20 is positioned within a tool crib 42 having a cavity 44 corresponding in shape to the tool 44. Consequently, an upper open end 48 of the cavity 44 is hexagonal in shape. Thus, with the tool 20 positioned within the crib 42, the tool crib 42 simply but effectively prevents rotation of the tool 20 relative to the tool crib 42.

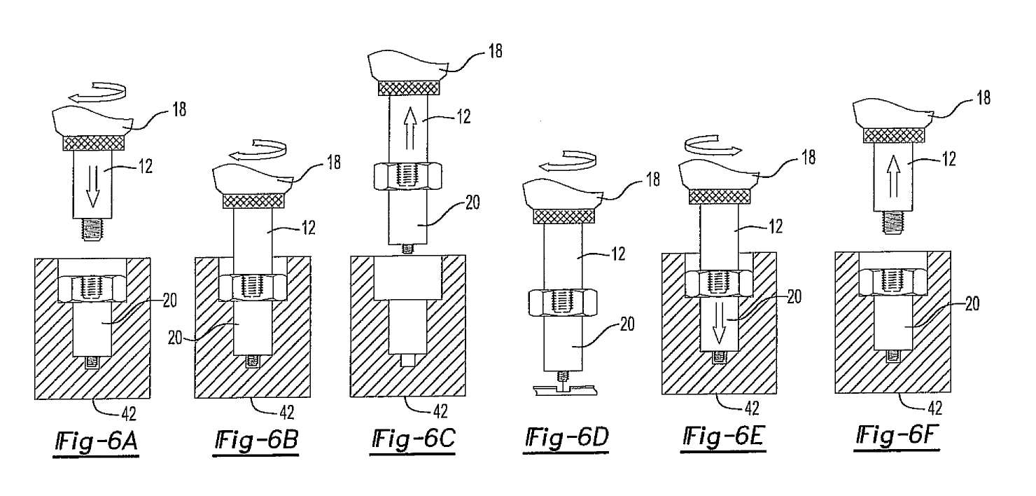

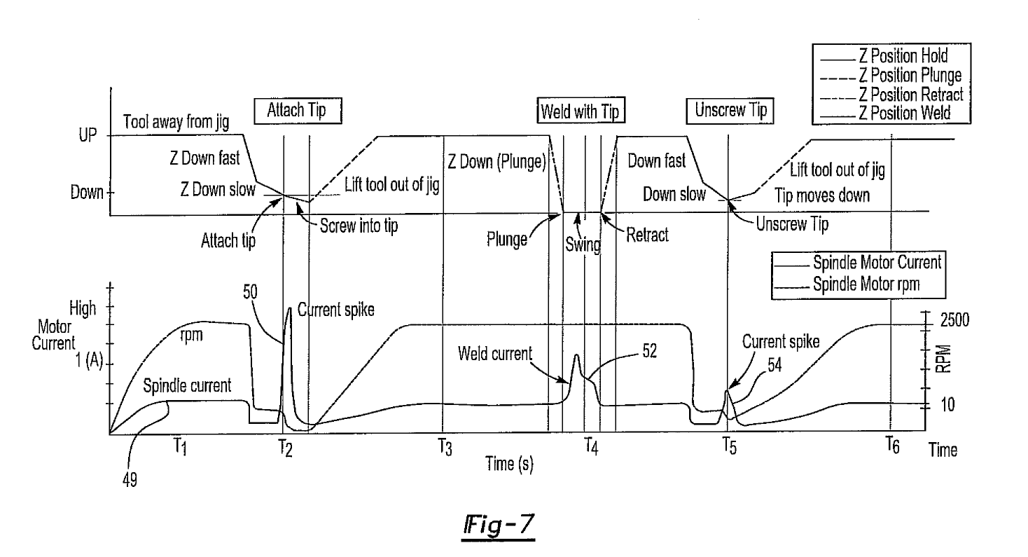

With reference now to FIGS. 6A-6F and 7, the sequence of operation for attaching and detaching the tool 20 to and from the holder 12 is illustrated diagrammatically. In FIG. 6A, the tool 20 is positioned within the crib 42 and the holder 12 is positioned above the crib 42 so that the axis of the holder 12 is aligned with the axis of the tool 20. Assuming that the fastener part 36 is a threaded shank, the tool holder is then rotatably driven in a first direction and simultaneously advanced towards the tool 20 to the position shown in FIG. 6B beginning at time T1. In doing so, the holder 12 and tool 20 are secured together with their second ends 32 and 34, respectively, in flat abutment with each other. Furthermore, during the attaching process the tool crib 42 effectively prevents rotation of the tool 20.

Any conventional means may be utilized to both detect and ensure that the holder 12 and tool 20 are secured together as shown at FIG. 6B. However, assuming that the rotary drive mechanism 18 is powered by an electric motor, the motor current 49 may be monitored as shown in FIG. 7 in order to detect a current spike 50 at time T2. Such a current spike 50 is indicative that the motor has encountered increased torque that would occur once the holder 12 is firmly attached to the tool 20. Alternatively, a torque sensor can be used to measure the torque on the tool to detect attachment and detachment of the tool 20 and holder 12.

After the holder 12 is attached to the tool 20 as shown in FIG. 6A, the holder with the attached tool 20 is then retracted as shown in FIG. 6C thus lifting the tool 20 out of the crib 42 immediately after time T2. The tool may then be used in a manufacturing operation as shown in FIG. 6D during time T4. Furthermore, during such a manufacturing operation, the motor current increases as shown at 52. Consequently, the absence of a current increase during the manufacturing operation would be indicative of a tool failure or machine failure of some sort.

After the manufacturing operation, the holder 12 with the attached tool 20 is then moved to the position shown in FIG. 6E in which the tool 20 is repositioned within the crib 42. At time T5-T6 the holder 12 is then rotatably driven in the opposite rotational direction from that used to attach the holder 12 and tool 20 together as shown in FIG. 6B. Additionally, a relatively small current spice 54 may be detected at the initiation of the detachment of the tool 20 from the holder 12 at time T5. Once this current spike 54 has ended, the holder 12 and tool 20 are disconnected from each other. The holder 12 may be then axially retracted away from the tool 20 as shown in FIG. 6F.

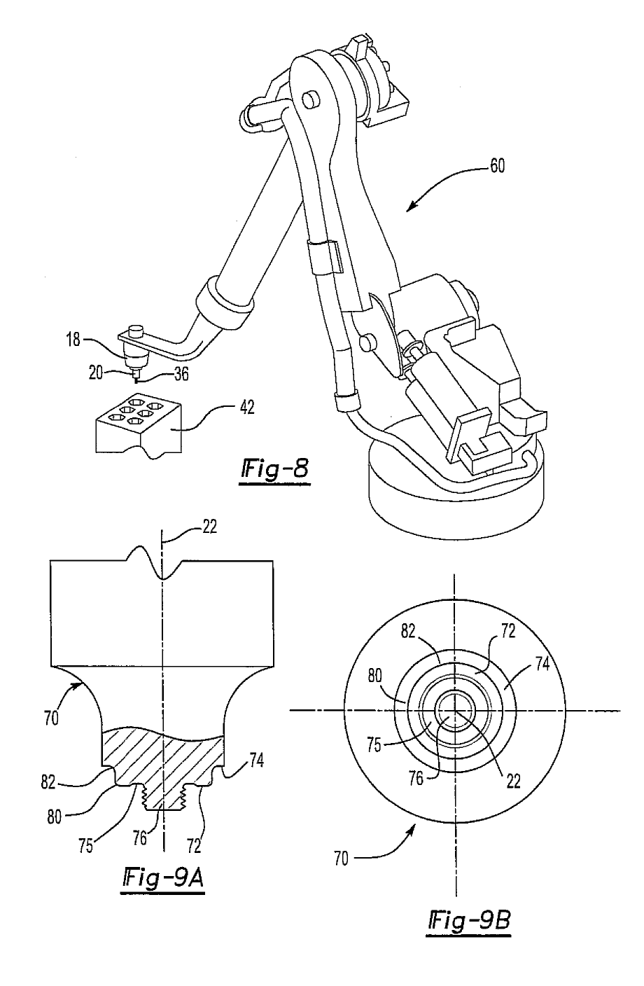

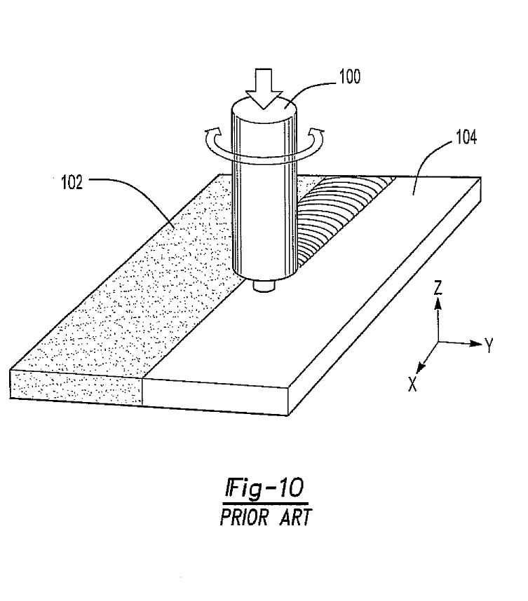

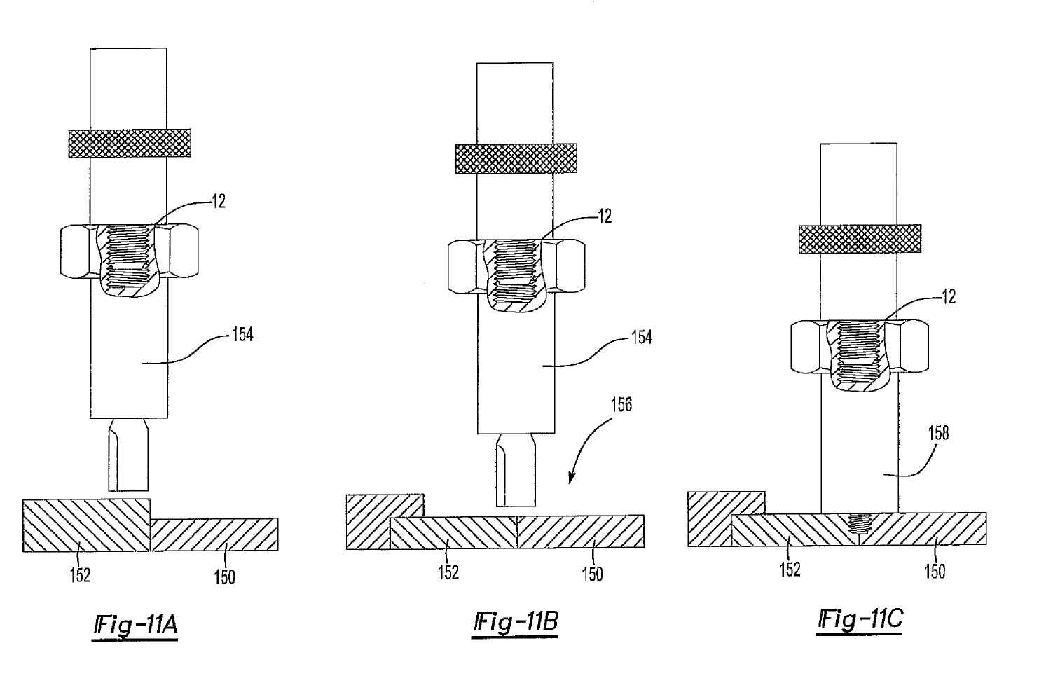

With reference now to FIG. 8, the tool assembly 10 of the present invention is particularly well suited for use with a robotic arm 60. In this case, the rotary drive mechanism 18 is carried by the robotic arm 60 while the tool crib 42 with a plurality of different tools 20 is positioned at a predetermined position relative to the robotic arm. Consequently, under program control, the robotic arm 60 attaches the holder 12 to the selected tool in the crib and then removes that tool to perform the desired machining operation. Upon completion of the desired machining operation, the robotic arm 60 returns the tool 20 to the crib 42 and detaches the holder 12 from the tool 20 as depicted in FIGS. 6E and 6F.

With reference now to FIGS. 11A-11C, an exemplary sequence of machining operations is illustrated. In FIG. 11A two plates 150 and 152 are butted together in preparation for a butt weld but the plate 152 is slightly thicker than the plate 150. In order for the plates 150 and 152 to be friction stir welded together, the plates 150 and 152 should have a substantially flat surface for contact with the friction stir welding tool.

Consequently, a milling or grinding tool 154 is first attached to the holder 12 and manipulated by a robotic arm or otherwise to machine the plate 152 as shown in FIG. 11B so that the plates 150 and 152 are flat along the weld as shown at 156. The milling or grinding tool 154 is then retracted as shown in FIG. 11B and replaced with a friction stir welding tool 158. The holder 12 with the attached friction stir welding tool is then manipulated by a robotic arm or otherwise as shown in FIG. 11C to weld the plates 150 and 152 together.

With reference now to FIGS. 9A and 9B, a friction stir welding tool 70, previously illustrated in FIG. 2B, is there shown in greater detail. The tool 70 includes a pair of coaxial annular radial surfaces 72 and 74 formed around a stir welding tip 76 of the tool 70. The surfaces 72 and 74, furthermore, are axially spaced apart along the tool 70 while an axially extending cylindrical surface 78 connects the surfaces 72 and 74. A recessed annular surface 75 is also formed around the threaded tool tip 24.

A radiused surface 80 is formed on the tool at the junction of the annular surface 72 and cylindrical surface 78 which causes the burr to grow axially along the tool, rather than radially outwardly during a friction stir welding operation. A second radiused surface 82 is formed at the junction of the cylindrical surface 80 and the second annular surface. This second radiused surface 82 then engages and flattens the burr.

The size of the radiused surfaces 80 and 82 is not critical. However, a radius of 0.025 inches for the radiused surfaces 80 and 82 will effectively reduce the burr for most applications.

In practice, the friction stir welding tool 70 illustrated in FIGS. 9A and 9B produces a smaller burr or welding bulge than previously known conventional friction stir welding tools. Such a smaller burr, in turn, reduces the amount of post-welding machining that may be required for the welded component.

From the foregoing, it can be seen that the present invention provides a simple and yet highly effective tool assembly that is particularly well suited for friction stir welding as well as other machining operations. Furthermore, since the tool assembly of the present invention may be used with a robotic arm, a plurality of tools, each having different manufacturing or machining tool tips, may be maintained within the crib and selectively attached to the holder as required. This in turn enables the robot to rapidly perform sequential and different machining operations.

1. The invention wherein one part of said fastener comprises a shank having a noncircular cross-sectional shape and the other part of said fastener comprises a bore having a cross-sectional shape complementary to said shank and wherein at least one of said fastener parts is magnetized.

2. The invention wherein one part of said fastener comprises a shank having a noncircular cross-sectional shape and the other part of said fastener comprises a bore having a cross-sectional shape complementary to said shank and wherein at least one of said fastener parts is magnetized.

3. A friction stir welding tool comprising:
a shank having an axis and one end adapted to be rotatably driven by a rotary drive mechanism about said axis,
a friction stir welding tip attached to the other end of said shank,
said friction stir welding tip having at least two flat annular surfaces of decreasing diameter so that said annular surfaces are coaxial and axially spaced apart from each other and joined by a cylindrical surface,
a threaded pin extending coaxially outwardly from the smaller diameter annular surface,
wherein a radiused surface is formed at the junction of said cylindrical surface with each annular surface.

4. The invention as defied in claim 3 and further comprising a recessed annular surface immediately surrounding said tip.

5. A method for welding components together by friction stir welding comprising the steps of:
attaching one end of a holder having an axis to a robotic arm such that said robotic arm rotatably drives said holder about said axis under program control, said holder having a first fastener part at its other end,
providing a plurality of friction stir welding tools in a crib at a predetermined location relative to the robotic arm, each tool having a second fastener part complementary to said first fastener part,
activating said robotic arm to selectively attach the first fastener part to the second fastener part on a selected tool,
performing a manufacturing operation with the selected tool,
thereafter activating said robotic arm to return said selected tool to said crib, and
disengaging said selected tool from said holder.

6. The invention as defined in claim 5 wherein one of said fastener parts comprises a threaded shank and the other fastener part comprises a complementary threaded bore.

7. The invention as defined in claim 5 wherein said performing step comprises the step of rotatably driving said holder and selected tool in a first rotational direction and wherein said disengaging step comprises the step of rotatably driving said holder in the opposite rotational direction.

8. The invention as defined in claim 7 and further comprising the step of preventing rotation of the selected tool during said disengaging step.

9. The invention as defined in claim 7 wherein an electric motor is used to rotatably drive the holder and wherein said attaching step further comprises the steps of monitoring the current of the electric motor and terminating rotation of the holder when the current exceeds a predetermined threshold.
